(19) United States
(12) Patent Application Publication
(10) Pub. No.: US 2005/0240775 A1
(43) Pub. Date: Oct. 27, 2005

(54) Apparatus and method for accessing a plurality of features requiring user credential information

(76) Inventor: Peter M. Chan, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/831,782

(22) Filed: Apr. 26, 2004

(51) Int. Cl. H04L 9/00

(52) U.S. Cl. 713/182

(57) ABSTRACT

An apparatus for enabling a user device to access a plurality of features requiring credential information of the user, includes a storage unit for storing information of the user required by the feature to which an access is desired by the user. A processor selects the information of the user from the storage unit corresponding to the feature to which the access is desired, based on another information about the user.

### BACKGROUND OF THE INVENTION

It is often desirable for a user to access one or more features such as computer applications, databases, programs for enabling access to networks, etc., without entering different feature specific user credential information for each feature. For example, a user may want to access the Internet using a notebook (or laptop) computer via a wireless “hotspot” provided by a commercial establishment such as a coffee shop, and then re-establish the access to the Internet at another location, perhaps at an airport. Another example might be a user accessing a local area network (LAN) via a personal computer (PC) in one office and then access the same LAN through another PC at another office.

In the above examples, the user is required to submit credential information such as name, password, address, social security number, etc., each time the user moves to another access location or to another computer. The type of credential information required at these different locations typically will not be the same. For example, one wireless hotspot may require a name and password specific to its location, and another hotspot may require a name, password and a social security number specific to its location.

### SUMMARY OF THE INVENTION

An apparatus for enabling a user device to access a plurality of features requiring credential information of the user, includes a storage unit for storing information of the user required by the feature to which an access is desired by the user. A processor selects the information of the user from the storage unit corresponding to the feature to which the access is desired, based on another information about the user.

### BRIEF DESCRIPTION OF THE DRAWINGS

FIG. 1 is a block diagram illustrating the connection between one embodiment of the invention and a number of features requiring credential information;

FIG. 2 is a block diagram illustrating an alternate connection between the embodiment of the invention of FIG. 1 and a number of features requiring credential information;

FIG. 3 is a block diagram of a principal manager shown in FIGS. 1 and 2;

FIG. 4 is an illustrative diagram of a storage unit of the principal manager shown in FIG. 3;

FIG. 5 is an illustrative diagram of a principal shown in FIG. 4;

FIG. 6 is an illustrative diagram of the principal shown in FIG. 4 in accordance with another embodiment of the invention; and,

FIG. 7 is a block diagram of a processor shown in FIG. 3.

### DETAILED DESCRIPTION

Broadly stated, the embodiments of the present invention is directed to apparatus and methods for enabling a user to access various features without the user entering credential information specific to each feature each time a particular feature is accessed. A feature independent principal manager stores credential information for all the features that the user is authorized to access, and supplies information corresponding to a particular feature as required to access that feature. In this manner, it is not necessary for a user to provide features specific credential information each time a feature is accessed.

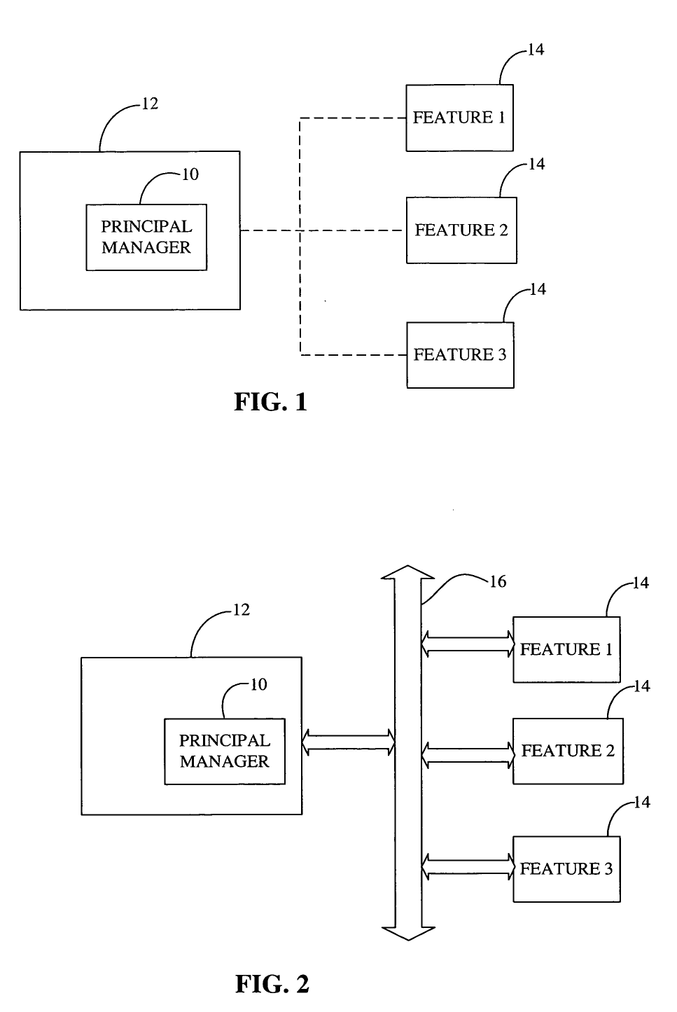

Turning now to FIGS. 1 and 2, a principal manager 10 enables a user device 12 to access a plurality of features 14 (three shown), such as computer applications, databases, or programs for enabling connections to a network such as the Internet or a LAN, etc. The principal manager 10 connects the user device 12 to the features 14 via direct hardwire or to remote locations through a landline or a wireless connection (best shown in FIG. 1). Communication between the features 14 and the user device 12 may also be through a network 16 such as a LAN, a WAN or the Internet, etc. (best shown in FIG. 2). The user device 12 may be a desktop computer, a portable notebook or laptop computer, or other devices such as a personal digital assistant (PDA), a cell phone, etc. The user device 12 may also be an AccessCard, which is typically implemented as a badge that is assigned to an employee for granting access to buildings and for charging a credit on the badge when it is used on the site cafeteria, for example.

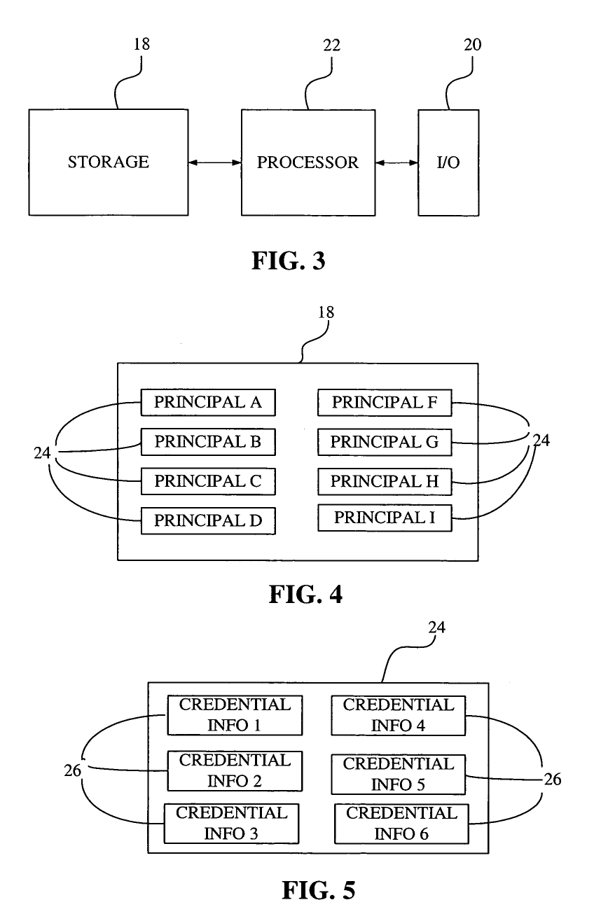

Referring to FIG. 3, the principal manager 10 includes a storage unit 18, an input/output (I/O) unit 20 and a processor 22. The storage unit 18 stores records of one or more principals 24 (best shown in FIG. 4), each of which holds credential information (best shown in FIG. 5) such as, for example, user name, password, address, date of birth, home address and telephone number, etc. Each principal 24 corresponds to a particular user. Thus, credential information stored in PRINCIPAL A (best shown in FIG. 4), for example, relates to user A. Cooperatively with instructions from processor 22, the storage unit 18 stores new principal records, modified existing principal records, and sends credential information to the processor 22.

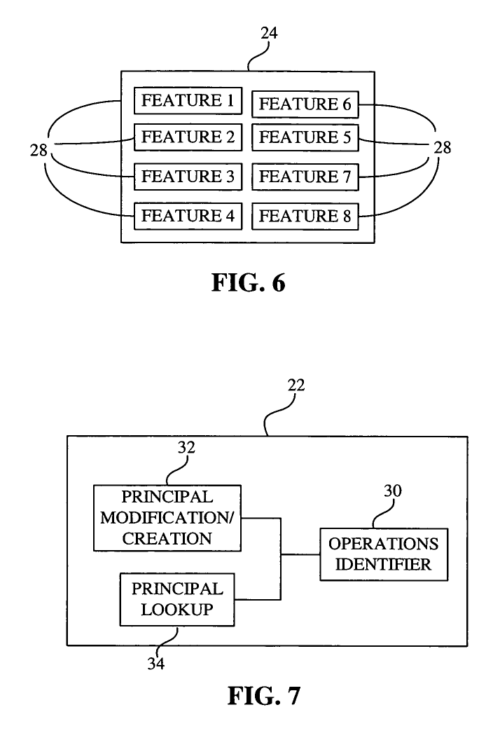

The credential information 26 within each principal 24 is stored in the storage unit 18 independently of features (best shown in FIG. 5). When credential information is required for a particular feature 26, the relevant information is selected, e.g., CREDENTIAL INFO 1 and 2, and transmitted to the features. In another embodiment, credential information is pre-grouped within a principal according to the different features 28 that a user is entitled to access (best shown in FIG. 6). For example, FEATURE 1 may include CREDENTIAL INFO 1 and 2; FEATURE 2 may include CREDENTIAL INFO 1, 2 and 4; and FEATURE 3 may include CREDENTIAL INFO 1, 3 and 4.

Referring back to FIG. 3, the I/O unit 20 interfaces with features to which a user is authorized to access, and receives authentication requests, i.e., requests for credential information 26 from the feature. An interface may be accomplished through a hardwire connection directly to the device supporting the feature or through a wireless connection. An interface may also be through a computer network.

The I/O unit 20 passes requests received from a feature to the processor 22, and also transmits data or credential information received from the processor 22 to the feature. The I/O unit 20 also functions as a user interface to interact with the user via input devices such as a keyboard and a monitor (not shown). More specifically, the I/O unit 20 translates data returned by the processor 20 into human readable text and displays the text to the user, and receives data input from the user such as credential information 26 for initially storing in the storage unit 18 or for modifying existing credential information. The I/O unit 20 also receives requests from the user to check or lookup principals 24 and credential information 26 associated with those principals stored in the storage unit 18.

The storage unit 18 may be provided locally in the user device 12, or centrally at a remote location such as on a network server (not shown), so as to enable access to the storage unit 18 from multiple processors 22. The storage unit 18 can also be implemented as distributed disks located over a LAN, for example. To enable data exchange between the remote storage unit 18 and the processor 22, the I/O unit 20 further functions as a remote interface to facilitates communication between the storage unit 18 and the processor 22. The connection between the I/O unit 20 and the remote storage unit 18 may be through a landline or by a wireless connection, or through a network 16 such as a LAN or a WAN, or the Internet, etc.

Turning now to FIG. 7, the processor 22 includes an operations identifier 30 for identifying data received from the I/O unit 20 and passing the data to either a principal modification/creation unit 32 or a principal lookup unit 34. The principal modification/creation unit 32 creates new principal records from credential information 26 initially provided by the user through the user interface of the I/O unit 20, and modifies existing principals 24 with new or updated information supplied by the user. The principal lookup unit 34 locates and retrieves credential information of interest from the principal 24 corresponding to the user either at the request of the user through the user interface of the I/O unit 20, or in response to an authentication request from features. As an alternative to having the principal modification/creation unit 32 and the principal lookup unit 34 incorporated into a single processor 22, the functions of these two units 32, 34 may also be performed by two separate processors 22.

In operation, once the I/O unit 20 interfaces with the desired feature to which a user is authorized to access, the user provides information sufficient to identify himself to the principal manager 10 (via the user interface with the I/O unit), for example, the user's name and a password. From this information, the processor 22 communicates with the storage unit 18 to locate the principal 24 corresponding to the user, and retrieves the credential information 26 specific to the desired feature. The retrieved credential information 26 is then supplied to the feature to gain access. Thus, the user is required to know and provide the information for accessing the principal manager 10, and not the specific set of credential information particular to the feature of interest.

In one example scenario, a user may enter a coffee shop with a wireless hotspot and seek access to the Internet through a laptop computer. When the laptop is within the wireless coverage area of the hotspot, the I/O unit 20 automatically interfaces with the coffee shop's Internet access system. Once the interface has been accomplished, the user makes an identifying data entry, e.g. a username and a password, in the principal manager 10 via the user interface of the I/O unit 20. In response, the processor 22 queries the storage unit 18 provided in the user device 12, i.e., the laptop computer, and retrieves the previously created credential information 26 corresponding to the coffee Internet access system. This information is presented to the coffee shop's Internet access system through the I/O unit 20. The Internet access system checks the validity of the presented credential information 26. If it is determined that the presented credential information 26 is valid, an appropriate access (the nature and extent of which may vary from user to user) is granted, and the user may use the hotspot to access the Internet.

In this scenario, the user now moves to another location having a different feature, a hardwire access point to the Internet at an airport, for example. When the I/O unit 20 interfaces with the Internet access system at the airport, the user again makes the same identifying entry previously made to access the Internet at the coffee shop (i.e., the same user name and the password) in the principal manager 10, via the user interface of the I/O unit 20. In response, the processor 22 queries the storage unit 18 and retrieves the previously created credential information corresponding the Internet access system at the airport from the storage unit. This information is presented to the airport Internet access system through the I/O unit 20. The Internet access system checks the validity of the presented credential information 26. If it is determined that the presented credential information 26 is valid, an appropriate access (the nature and extent of which may vary from user to user) is granted, and the user may use the access system at the airport to access the Internet.

As illustrated in the above scenario, the user is only required to know the information for accessing the principal manager 10 itself, and not for each individual features. Once the credential information 26 for interested features have been initially created in the storage unit 18, the principal manager 10 in accordance with the embodiments of the invention is effectively feature independent.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the present invention are set forth in the appended claims.

1. An apparatus for enabling a user device to access a plurality of features requiring credential information of the user, comprising:
at least one storage unit for storing first information of a user required by at least a feature to which an access is desired by the user; and
a processor for selecting said first information of the user from said at least one storage unit corresponding to the feature to which the access is desired;
wherein said first information of the user is selected based on second information of the user.

2. The apparatus as defined claim 1, wherein said processor comprises:
first means for creating or modifying said first information stored in said storage unit; and
second means for searching said storage unit for said first information of the desired feature.

3. The apparatus as defined claim 2, wherein said processor further includes third means for selecting one of said first and second means.

4. The apparatus as defined claim 1, further comprising an interface unit for interfacing with the desired feature for receiving requests for said first information of the user from the desired feature, and transmitting the selected first information of the user to the desired feature.

5. The apparatus as defined claim 4, wherein said interface unit interfaces with the desired feature via a wireless connection, a hardwire connection or through a network.

6. The apparatus as defined claim 1, wherein said first information is credential information of the user.

7. The apparatus as defined claim 6, wherein said storage unit stores said credential information of the user corresponding to the plurality of features, and said credential information of the user corresponding to any of said plurality of features is selected based on said second information of the user.

8. The apparatus as defined claim 1, wherein said at least one storage unit is remotely located from said processor.

9. The apparatus as defined claim 8, wherein said at least one storage unit comprises a plurality of storage units distributed over a network.

10. The apparatus as defined claim 8, wherein said at least one storage unit stores first information of a plurality of users corresponding to a plurality of features, and first information of a select user corresponding to any of said plurality of features is selected based on said second information of said select user.

11. The apparatus as defined claim 10, further comprising an interface unit for enabling said processor to access said storage unit.

12. The apparatus as defined claim 11, wherein said processor accesses the storage unit via a wireless connection, a hardwire connection or through a network.

13. The apparatus as defined claim 11, wherein said interface unit transmits the selected first information of the select user to the desired feature.

14. The apparatus as defined claim 13, wherein interface unit accesses the desired feature via a wireless connection, a hardwire connection or through a network.

15. The apparatus as defined claim 10, wherein said first information is credential information of the user.

16. The apparatus as defined claim 1, wherein the user device comprises a personal computer.

17. The apparatus as defined claim 1, wherein the user device comprises a personal digital assistant (PDA).

18. The apparatus as defined claim 1, wherein the user device comprises a cell phone.

19. The apparatus as defined claim 1, wherein the user device comprises an AccessCard.

20. A method for enabling a user device to access a plurality of features requiring credential information of the user, comprising:
storing first information of the user required by at least a feature to which an access is desired by the user in a storage unit;
selecting first information of the user from said storage unit corresponding to the feature to which the access is desired, when second information of the user provided by the user; and
transmitting said selected first information to the feature to which the access is desired.

21. The method as defined claim 20, wherein said storage unit is remotely located from the user device, and stores said first information of a plurality of users.

22. The method as defined claim 20, further comprising interfacing with the feature to which the access is desired, for receiving requests for said first information of the user from the feature.

23. The method as defined claim 20, further comprising storing first information of a plurality of users required by a plurality of features to which an access is desired.

24. An apparatus for gaining access to a plurality of features requiring credential information of a user, comprising:
a storage unit for storing credential information of the user required by at least a feature to which an access is desired by the user;
a processor for selecting credential information of the user from said storage unit corresponding to the feature to which an access is desired; and
an interface unit for interfacing with the feature to which an access is desired for receiving requests for credential information of the user, and transmitting the selected credential information of the user to the feature to which the access is desired;
wherein said credential information of the user is selected based on the common information provided by the user.

25. The apparatus as defined claim 24, wherein said processor creates and modifies the credential information stored in said storage unit.

26. The apparatus as defined claim 24, wherein said interface unit interfaces with the feature to which the access is desired via a wireless connection, a hardwire connection or through a network.

27. The apparatus as defined claim 24, wherein said storage unit is remotely located from said processor.

28. The apparatus as defined claim 27, wherein said storage unit stores credential information of a plurality of users corresponding to a plurality of features, and first information of a select user corresponding to any of said plurality of features is selected based on said second information of said select user.

29. The apparatus as defined claim 28, wherein said interface unit enables said processor to access said storage unit.

30. The apparatus as defined claim 29, wherein a connection between said interface unit and said storage unit is via a wireless connection, a hardwire connection or through a network.

31. The apparatus as defined claim 24, wherein said apparatus comprises a personal computer.

32. The apparatus as defined claim 19, wherein said apparatus comprises a personal digital assistant (PDA).

33. The apparatus as defined claim 19, wherein said apparatus comprises a cell phone.
